(19) United States
(12) Patent Application Publication
(10) Pub. No.: US 2011/0249931 A1
(43) Pub. Date: Oct. 13, 2011

(54) ROLLER BEARING, MAIN SHAFT SUPPORT STRUCTURE OF WIND POWER GENERATOR, AND METHOD FOR ADJUSTING CIRCUMFERENTIAL CLEARANCE BETWEEN RETAINER SEGMENTS OF ROLLER BEARING

(75) Inventors: Tatsuya Omoto, Kuwana-shi, Mie (JP); Eiichi Nakamizo, Mie (JP)

(73) Assignee: NTN CORPORATION, Osaka (JP)

(21) Appl. No.: 13/120,221

(22) PCT Filed: Sep. 1, 2009
(86) PCT No.: PCT/JP2009/065243

§ 371 Date: Jun. 7, 2011

(30) Foreign Application Priority Data
Sep. 30, 2008 (JP) 2008-253678

(51) Int. Cl. F16C 33/58; B21D 53/10

(52) U.S. Cl. 384/572; 29/898.04

(57) ABSTRACT

A tapered roller bearing (31) has pockets to house tapered rollers (34) and includes a plurality of retainer segments (11a) to (11d) arranged so as to be continuously lined with each other in a circumferential direction between an outer ring (32) and an inner ring (33). The retainer segments (11a) to (11d) include at least a first retainer segment having a first circumferential length, and a second retainer segment having a second circumferential length different from the first circumferential length. After the retainer segments (11a) to (11d) have been arranged in the circumferential direction without space therebetween, a circumferential clearance (39) is provided between the retainer segment (11a) arranged first and the retainer segment (11d) arranged last. A circumferential range of the clearance is larger than 0.08% and smaller than 0.10% of a circumference of a circle passing through a center of the retainer segment at room temperature.

### TECHNICAL FIELD

The present invention relates to a main shaft support structure of a wind power generator and a method for adjusting a circumferential clearance between retainer segments of a roller bearing, and more particularly to a roller bearing including a plurality of retainer segments arranged in a circumferential direction to compose one retainer, a main shaft support structure of a wind power generator including the roller bearing, and a method for adjusting a circumferential clearance between the retainer segments of the roller bearing.

### BACKGROUND OF THE INVENTION

In general, a roller bearing is composed of an outer ring, an inner ring, a plurality of rollers arranged between the outer ring and the inner ring, and a retainer to retain the plurality of rollers. The retainer is normally composed of an integral, that is, annular component.

As for a roller bearing to support a main shaft of a wind power generator provided with a blade to receive wind, since it is required to receive a high load, the roller bearing itself is large in size. Accordingly, each component member such as a roller or a retainer to compose the roller bearing is also large in size, so that it is difficult to produce or assemble the member. In this case, when each member can be split, the component can be easily produced or assembled.

Here, a technique regarding a split-type retainer in which a retainer in a roller bearing is split by a split line extending in a direction along a rotation axis of the bearing is disclosed in European Patent No. 1408248A2 (Patent document 1). FIG. 10 is a perspective view showing a retainer segment of the split-type retainer disclosed in the patent document 1. Referring to FIG. 10, a retainer segment 101a has a plurality of column parts 103a, 103b, 103c, 103d, and 103e extending in the direction along the rotation axis of the bearing so as to form a plurality of pockets 104 to house rollers, and connection parts 102a and 102b extending in a circumferential direction so as to connect the plurality of column parts 103a to 103e.

FIG. 11 is a cross-sectional view showing a part of a tapered roller bearing including the retainer segment 101a shown in FIG. 10. A description will be made of a configuration of a tapered roller bearing 111 including the retainer segment 101a, with reference to FIGS. 10 and 11. The tapered roller bearing 111 has an outer ring 112, an inner ring 113, a plurality of tapered rollers 114, and a plurality of retainer segments 101a, 101b, and 101c to retain the plurality of tapered rollers 114. The tapered rollers 114 are retained by the retainer segments 101a and the like in the vicinity of a PCD (Pitch Circle Diameter) 105 in which roller behavior is most stable. The retainer segment 101a to retain the tapered rollers 114 is continuously lined to the adjacent retainer segments 101b and 101c having the same shape in such a manner that the column parts 103a and 103e positioned on the outermost sides abut on them, respectively. The retainer segments 101a, 101b, 101c, and the like are lined with each other and assembled in the tapered roller bearing 111, whereby one annular retainer is formed in the tapered roller bearing 111.

### BACKGROUND ART DOCUMENT

### Patent Document

Patent document 1: European Patent No. 1408248A2

### SUMMARY OF THE INVENTION

### Problems to be Solved by the Invention

According to the patent document 1, a circumferential clearance generated between the first retainer segment and the last retainer segment after the retainer segments made of a resin have been arranged so as to be continuously lined with each other in the circumferential direction is set to be 0.15% or more and less than 1% of a circumference of a circle passing through a center of the retainer segment. In this configuration, a collision sound is prevented from being generated between the retainer segments, and the retainer segments are prevented from being tightened due to thermal expansion.

In addition, according to the patent document 1, the retainer segment is made of polyphenylene sulfide (hereinafter, referred to as “PPS”) or polyether ether ketone (hereinafter, referred to as “PEEK”).

However, even when the circumferential clearance is limited into the above value range, the following problem on which the inventor focused cannot be solved. FIG. 12 is a schematic cross-sectional view showing a part of the tapered roller bearing 111 in a case where the tapered roller bearing 111 is used as a bearing to support a main shaft of a wind power generator. In addition, to be easily understood, a circumferential clearance 115 generated between the retainer segments 101a and 101c is overdrawn.

Referring to FIG. 12, a main shaft 110 of the wind power generator supported by the tapered roller bearing 111 is used horizontally. While the tapered roller bearing 111 is used, the retainer segments 101a to 101c make a revolution movement in a direction shown by arrows in FIG. 12. The revolution movement of the retainer segments 101a to 101c is performed such that the respective retainer segments 101a to 101c sequentially push the adjacent retainer segments 101a to 101c in the direction shown by the arrows. In this case, the tapered roller and the retainer segment 101a free-fall at a part shown by XII in FIG. 12. In this case, the retainer segments 101a collides with the retainer segment 101c, which causes deformation, end face abrasion, and collision sound between the retainer segments 101a and 101c, and accordingly could cause considerable functional decline in the tapered roller bearing 111.

In the case where the tapered roller bearing 111 is used as the bearing to support the main shaft 110 of the wind power generator, the retainer segments 101a to 101c themselves are large in size, so that the problem caused by the collision at the time of free-fall is serious. Therefore, the circumferential clearance set in the above is not satisfactory, and it is necessary to further reduce the circumferential clearance. Here, in order to reduce the circumferential clearance more than the above range, it is necessary to strictly control a circumferential length of the retainer segment. However, the roller bearing including such retainer segment is difficult to produce, and the circumferential clearance becomes large, which causes functional decline.

It is an object of the present invention to provide a roller bearing in which functional decline can be easily prevented.

It is another object of the present invention to provide a main shaft support structure of a wind power generator in which functional decline can be easily prevented.

It is still another object of the present invention to provide a method for adjusting a circumferential clearance between retainer segments by which a circumferential clearance can be easily adjusted.

### Means for Solving the Problem

A roller bearing according to the present invention includes an outer ring, an inner ring, a plurality of rollers arranged between the outer ring and the inner ring, and pockets to house the rollers, and further includes a plurality of retainer segments arranged so as to be continuously lined with each other in a circumferential direction between the outer ring and the inner ring. The plurality of retainer segments include at least a first retainer segment having a first circumferential length, and a second retainer segment having a second circumferential length different from the first circumferential length. A circumferential clearance is provided between the retainer segment arranged first and the retainer segment arranged last after the plurality of retainer segments have been arranged in the circumferential direction without space therebetween. A circumferential range of the clearance is larger than 0.08% and smaller than 0.10% of a circumference of a circle passing through a center of the retainer segment at room temperature.

The bearing component member such as the outer ring, the inner ring, or the roller provided in the roller bearing is made of steel such as case-hardening steel, in general. The bearing component member such as the outer ring is also thermally expanded due to temperature change. Here, taking account of a thermal linear expansion coefficient of the retainer segment and a thermal linear expansion coefficient of the bearing component member, the circumferential range of the clearance can be reduced to 0.08% of the circumference of the circle passing through the center of the retainer segment at room temperature in actual usage circumstances. That is, when the circumferential range of the clearance is set to be larger than 0.08% of the circumference, the circumferential clearance is prevented from becoming negative, so that the retainer segments are prevented from being pushed and stuck.

In addition, in the roller bearing used in the above usage, the retainer composed of the retainer segments preferably has a high safe ratio with a view to improving durability and reliability. The safe ratio of the retainer becomes high as the circumferential clearance is reduced. The safe ratio of the retainer is required to be 4.0 or more in view of fatigue strength of a material of the retainer segment and stress generated on the retainer segment. Here, the safe ratio can be surely 4.0 or more by setting the circumferential range of the clearance at room temperature to be less than 0.10% of the circumference of the circle passing through the center of the retainer segment. Thus, a strength defect caused by the collision between the retainer segments, including the above problem can be solved.

Here, the circumferential clearance generated between the retainer segments can be adjusted by combining at least the first retainer segment having the first circumferential length and the second retainer segment having the second circumferential length different from the first circumferential length, so that the circumferential clearance can be easily reduced. Thus, the circumferential clearance between the retainer segments can be set within the above range by combining at least the first retainer segment having the first circumferential length and the second retainer segment having the second circumferential length different from the first circumferential length, so that the strength defect caused by the collision between the retainer segments can be prevented, and the deformation caused by circumferential pressing between the retainer segments can be prevented. Therefore, the functional decline in the roller bearing having the above retainer segments can be easily prevented. In addition, the retainer segments include at least the first retainer segment having the first circumferential length and the second retainer segment having the second circumferential length different from the first circumferential length, which means that, as will be described below, the retainer segments may include a third retainer segment having a third circumferential length different from the first and second circumferential lengths, and may further include a retainer segment having a circumferential length different from those of the first, second, and third retainer segments.

Here, the retainer segment is a unit body obtained by dividing one annular retainer by a split line extending in a direction along a rotation axis of the bearing so as to form at least one pocket to house the roller. In addition, the first retainer segment means the retainer segment arranged first in sequentially arranging the retainer segments in the circumferential direction, and the last retainer segment means the retainer segment arranged last among the retainer segments arranged so as to be continuously lined to the adjacent retainer segment. Thus, the retainer segments are continuously lined with each other in the circumferential direction and assembled in the roller bearing, thereby composing the one annular retainer.

Preferably, the retainer segment is made of a resin. While productivity of the retainer segment is to be improved because the several retainer segments are used for one roller bearing, the retainer segment in this configuration can be easily mass-produced by injection molding or the like.

Still preferably, the resin is polyether ether ketone (PEEK). The material PEEK is low in thermal linear expansion coefficient as compared with other resins, and can easily lower the thermal linear expansion coefficient with a filler material contained therein.

Further preferably, the resin contains a filler material to lower the thermal linear expansion coefficient. Thus, since the retainer segment is made of the resin containing the filler material to lower the thermal linear expansion coefficient, a difference in thermal linear expansion coefficient can be small between the retainer segment and the bearing component member such as the outer ring in the roller bearing, thereby reducing a change in the circumferential clearance due to temperature change.

Still preferably, the filler material contains at least one of carbon fiber and glass fiber. In this case, since the filler material is made of the fiber, it can efficiently lower the thermal linear expansion coefficient.

Further preferably, the thermal linear expansion coefficient of the resin ranges from 1.3×10⁻⁵/° C. to 1.7×10⁻⁵/° C. The bearing component such as the outer ring in the bearing is made of steel such as case-hardening steel in general. A thermal linear expansion coefficient of steel is about 1.12×10⁻⁵/° C. Therefore, when the thermal linear expansion coefficient of the resin is set within the above range, a difference in thermal linear expansion coefficient between the retainer segment and the bearing component such as the outer ring is allowable in actual usage. In addition, a thermal linear expansion coefficient of PEEK is about 4.7×10⁻⁵/° C., and a thermal linear expansion coefficient of PPS is about 5.0×10⁻⁵/° C.

Further preferably, the thermal linear expansion coefficient of the retainer segment is equal to at least one of thermal linear expansion coefficients of the outer ring and the inner ring.

Still preferably, a filling rate of the filler material in the resin ranges from 20% by weight to 40% by weight. When the filling rate of the filler material in the resin is set within the above range, the thermal linear expansion coefficient of the resin can be considerably lowered without generating another defect caused because the filler material is contained.

Further preferably, the roller is a tapered roller. The roller bearing used in the main shaft of the above wind power generator has to receive high moment load, thrust load, and radial load. Here, when the tapered roller is used as the roller, it can receive the high moment load.

In another aspect of the present invention, a main shaft support structure of a wind power generator has a blade to receive wind power, a main shaft having one end fixed to the blade and rotating together with the blade, and a roller bearing incorporated in a fix member to rotatably support the main shaft. The roller bearing includes an outer ring, an inner ring, a plurality of rollers arranged between the outer ring and the inner ring, and pockets to house the rollers, and includes a plurality of retainer segments arranged so as to be continuously lined with each other in a circumferential direction between the outer ring and the inner ring. The plurality of retainer segments include at least a first retainer segment having a first circumferential length, and a second retainer segment having a second circumferential length different from the first circumferential length. A circumferential clearance is provided between the retainer segment arranged first and the retainer segment arranged last after the plurality of retainer segments have been arranged in the circumferential direction without space therebetween. A circumferential range of a clearance is larger than 0.08% and smaller than 0.10% of a circumference of a circle passing through a center of the retainer segment at room temperature.

Since the main shaft support structure of the wind power generator includes the roller bearing in which the functional decline in the bearing can be easily prevented, functional decline in the main shaft support structure of the wind power generator itself can be easily prevented.

In still another aspect of the present invention, according to a method for adjusting a circumferential clearance between retainer segments of a roller bearing having an outer ring, an inner ring, a plurality of rollers arranged between the outer ring and the inner ring, and pockets to house the rollers, and including a plurality of retainer segments arranged so as to be continuously lined with each other in a circumferential direction between the outer ring and the inner ring, a first retainer segment having a first circumferential length, and a second retainer segment having a second circumferential length different from the first circumferential length are prepared, and at least the first retainer segment and the second retainer segment are combined to adjust the circumferential clearance between the retainer segments.

By the method for adjusting the circumferential clearance between the retainer segments of the roller bearing, the circumferential clearance can be easily adjusted.

### Effect of the Invention

According to the present invention, the circumferential clearance generated between the retainer segments can be adjusted by combining at least the first retainer segment having the first circumferential length and the second retainer segment having the second circumferential length different from the first circumferential length, so that the circumferential clearance can be easily reduced. Thus, the circumferential clearance between the retainer segments can be set within the above range by combining at least the first retainer segment having the first circumferential length and the second retainer segment having the second circumferential length different from the first circumferential length, so that the strength defect caused by the collision between the retainer segments can be prevented, and deformation caused by circumferential pressing between the retainer segments can be prevented. Therefore, the functional decline in the roller bearing having the above retainer segments can be easily prevented.

In addition, since the main shaft support structure of the wind power generator includes the roller bearing in which the functional decline in the bearing can be easily prevented, the functional decline in the main shaft support structure of the wind power generator itself can be easily prevented.

In addition, by the method for adjusting the circumferential clearance between the retainer segments of the roller bearing, the circumferential clearance can be easily adjusted.

### BRIEF DESCRIPTION OF THE DRAWINGS

FIG. 1 is an enlarged cross-sectional view showing a circumferential clearance between a first retainer segment and a last retainer segment in a tapered roller bearing according to one embodiment of the present invention.

FIG. 2 is a perspective view of the retainer segment included in the tapered roller bearing according to one embodiment of the present invention.

FIG. 3 is a cross-sectional view in a case where the retainer segment shown in FIG. 2 is split by a plane passing through a line III-III in FIG. 2 and perpendicular to a rotation axis of the bearing.

FIG. 4 is a cross-sectional view in a case where the retainer segment shown in FIG. 2 is cut by a plane passing through the center of a column part and perpendicular to a circumferential direction.

FIG. 5 is a schematic cross-sectional view of the tapered roller bearing in which the retainer segments are arranged in the circumferential direction.

FIG. 6 is an enlarged cross-sectional view showing the adjacent retainer segments.

FIG. 7 is a graph showing a relationship between a safe ratio of the retainer and a circumferential clearance.

FIG. 8 is a view showing one example of a main shaft support structure of a wind power generator employing the tapered roller bearing according to the present invention.

FIG. 9 is a schematic side view of the main shaft support structure of the wind power generator shown in FIG. 8.

FIG. 10 is a perspective view of a conventional retainer segment.

FIG. 11 is a cross-sectional view in a case where a part of a tapered roller bearing including the retainer segment shown in FIG. 10 is cut by a plane perpendicular to a rolling axis of the bearing.

FIG. 12 is a schematic cross-sectional view in a case where the tapered roller bearing including the retainer segment shown in FIG. 10 is cut by a plane perpendicular to the rolling axis of the bearing.

### DESCRIPTION OF THE PREFERRED EMBODIMENTS

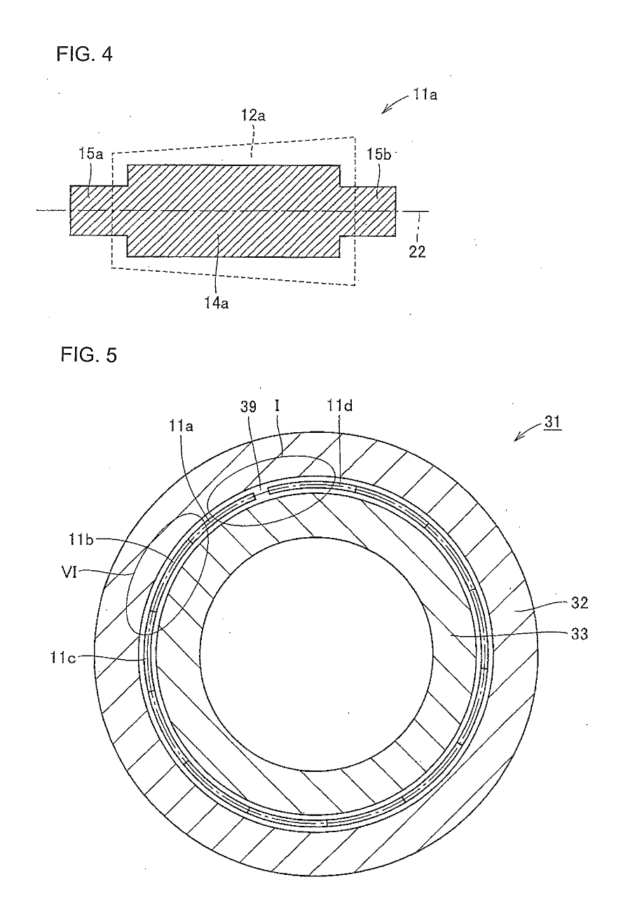

Hereinafter, an embodiment of the present invention will be described with reference to the drawings. FIG. 2 is a perspective view showing a retainer segment 11a provided in a tapered roller bearing according to one embodiment of the present invention. FIG. 3 is a cross-sectional view in a case where the retainer segment 11a shown in FIG. 2 is cut by a plane passing through a line III-III in FIG. 2 and perpendicular to a rotation axis of the bearing. FIG. 4 is a cross-sectional view in a case where the retainer segment 11a shown in FIG. 2 is cut by a plane passing through the center of a column part 14a and perpendicular to a circumferential direction. To be easily understood, a plurality of tapered rollers 12a, 12b, and 12c retained by the retainer segment 11a are shown by dotted lines in FIGS. 3 and 4. In addition, a PCD 22 is shown by a one-dot chain line. This retainer segment 11a is mostly applied to a large-size roller bearing in which an outer diameter dimension of an outer ring is 1000 mm or more, and an inner diameter dimension of an inner ring is 750 mm or more.

First, a description will be made of the retainer segment 11a of the tapered roller bearing with reference to FIGS. 2 to 4. The retainer segment 11a is formed by splitting an annular retainer by a split line extending along the rotation axis of the bearing so as to have at least one pocket to house the roller. The retainer segment 11a includes four column parts 14a, 14b, 14c, and 14d extending along the rotation axis of the bearing, and a pair of connection parts 15a and 15b positioned at axial both ends and extending in the circumferential direction so as to connect the four column parts 14a to 14d, so that pockets 13a, 13b, and 13c are formed to house the tapered rollers 12a, 12b, and 12c. Here, the retainer segment 11a is configured such that the column parts 14a and 14d are positioned at circumferential outer ends.

The pair of connection parts 15a and 15b has a predetermined circumferential curvature radius so that the plurality of retainer segments 11a are circumferentially connected to form the annular retainer after they have been incorporated in the tapered roller bearing. Of the pair of connection parts 15a and 15b, the curvature radius of the connection part 15a positioned on the small diameter side of the tapered rollers 12a to 12c is set to be smaller than the curvature radius of the connection part 15b positioned on the large diameter side of the tapered rollers 12a to 12c.

Regarding the column parts 14a and 14b positioned on circumferential both sides of the pocket 13a, and the column parts 14c and 14d positioned on circumferential both sides of the pocket 13c, inner-diameter side guide clicks 17a, 17b, 17c, and 17d are provided on the inner diameter side of side wall surfaces of the column parts 14a to 14d to regulate movement of the retainer segment 11a toward the radial outer side. The guide clicks 17a to 17d are in contact with the tapered rollers 12a and 12c housed in the pockets 13a and 13c on the inner diameter side. Regarding the column parts 14b and 14c positioned on circumferential both sides of the pocket 13b, outer-diameter side guide clicks 18b and 18c are provided on the outer diameter side of side wall surfaces of the column parts 14b and 14c to regulate movement of the retainer segment 11a toward the radial inner side. The guide clicks 18b and 18c are in contact with the tapered roller 12b housed in the pocket 13b on the outer diameter side. The respective guide clicks 17a to 17d, 18b, and 18c have shapes projecting toward the respective pockets 13a to 13c. In addition, in the cross-section shown in FIG. 3, the respective guide clicks 17a to 17d, 18b, and 18c have guide surfaces which are circular in cross-section so as to follow rolling surfaces of the respective tapered rollers 12a to 12c. Thus, since the guide clicks 17a to 17d, 18b, and 18c are provided on the inner diameter side and the outer diameter side, the retainer segment 11a is guided by the rollers which are in contact with the guide surfaces of the guide clicks 17a to 17d, 18b, and 18c. In addition, end faces 21a and 21b positioned on the circumferential outer sides of the column parts 14a and 14d are flat.

In addition, as several retainer segments 11a are needed in the one tapered roller bearing, productivity thereof is required to be high. Thus, in this configuration, the same shaped retainer segments can be produced in large numbers by a method such as injection molding.

In addition, since the retainer segment 11a is made of a resin containing a filler material to lower a thermal linear expansion coefficient, a difference in thermal linear expansion coefficient is small between the retainer segment and the bearing component member such as the outer ring in the tapered roller bearing, thereby reducing a change in circumferential length of the clearance due to temperature change.

In addition, the resin contains at least one selected from a group composed of polyamide (PA), polyacetal (POM), polybutylene terephthalate (PBT), polyethylene terephthalate (PET), syndiotactic polystyrene (SPS), polyphenylene sulfide (PPS), polyether ether ketone (PEEK), liquid crystal polymer (LCP), fluorine resin, polyether nitrile (PEN), polycarbonate (PC), modified polyphenylene ether (PPO), polysulfone (PES), polyether sulfone (PES), polyarylate (PAR), polyamide imide (PAI), polyether imide (PEI), and thermoplastic polyimide (PI). When the above resin appropriately contains the filler material, its thermal linear expansion coefficient can be lowered into the above range. In addition, several kinds of the above resins may be combined.

Here, the resin is preferably PEEK. The thermal linear expansion coefficient of PEEK itself is about 4.7×10⁻⁵/° C., and the thermal linear expansion coefficient is lower than those of the other resins, so that the thermal linear expansion coefficient of the resin containing the filler material can be easily lowered.

In addition, the filler material contains at least one of carbon fiber, glass fiber, graphite, carbon black, aluminum powder, iron powder, and molybdenum disulfide. Since the above filler material has high affinity with the resin, it can efficiently lower the thermal linear expansion coefficient. In addition, the several kinds of the above filler materials may be combined.

Here, the filler material preferably contains at least one of the carbon fiber and glass fiber. When the filler material contains the fiber, it can be efficiently lower the thermal linear expansion coefficient.

In addition, the thermal linear expansion coefficient of the resin preferably ranges from 1.3×10⁻⁵/° C. to 1.7×10⁻⁵/° C. The bearing component member such as the outer ring in the bearing is made of steel such as case-hardening steel in general. The thermal linear expansion coefficient of steel is about 1.12×10⁻⁵/° C. Therefore, when the thermal linear expansion coefficient of the resin is set within the above range, a difference in thermal linear expansion coefficient between the resin and the bearing component such as the outer ring is allowable in actual usage.

In addition, a filling rate of the filler material in the resin preferably ranges from 20% by weight to 40% by weight. In this case, another defect caused because the filler material is contained, such as strength poverty due to an excessive filler amount is not generated, and the thermal linear expansion coefficient of the resin can be considerably lowered.

More specifically, it is preferable that the retainer segment 11a made of PEEK contains 30% by weight of carbon fiber as the filler material, and has a linear expansion coefficient of 1.5×10⁻⁵/° C. In this case, the retainer segment 11a extremely differs in thermal linear expansion coefficient from a retainer segment made of PEEK whose thermal linear expansion coefficient is 4.7×10⁻⁵/° C., and a retainer segment made of PPS whose thermal linear expansion coefficient is 5.0×10⁻⁵/° C.

Here, among the above retainer segments 11a, the retainer segment 11a having a different circumferential length is included in the tapered roller bearing. That is, the retainer segments 11a in the tapered roller bearing include at least a first retainer segment having a first circumferential length and a second retainer segment having a second circumferential length. Here, the circumferential length means a circumferential length of a circle passing through the center of the retainer segment 11a, or a length shown by L in FIG. 3. More specifically, the first circumferential length is 100 mm, and the second circumferential length is 101 mm. That is, the tapered roller bearing which will be described below includes at least the first retainer segment having the circumferential length of 100 mm, and at least the second retainer segment having the circumferential length of 101 mm.

The circumferential length of the retainer segment 11a is adjusted such that thicknesses of the column parts 14a and 14d positioned on the circumferential outer sides are reduced, for example. More specifically, the retainer segment 11a having the different circumferential length is produced such that dies having different circumferential lengths are used for the column parts 14a and 14d at the time of molding of the retainer segment 11a, or the end faces 21a and 21b of the column parts 14a and 14d on the circumferential outer sides are cut. Here, the retainer segment 11a having the different circumferential length is prepared such that circumferential dimensions of the column parts 14a and 14d positioned on the circumferential outer sides are adjusted while the number of the pockets 13a to 13c, and the number of the column parts 14a to 14d are the same in each retainer segment 11a.

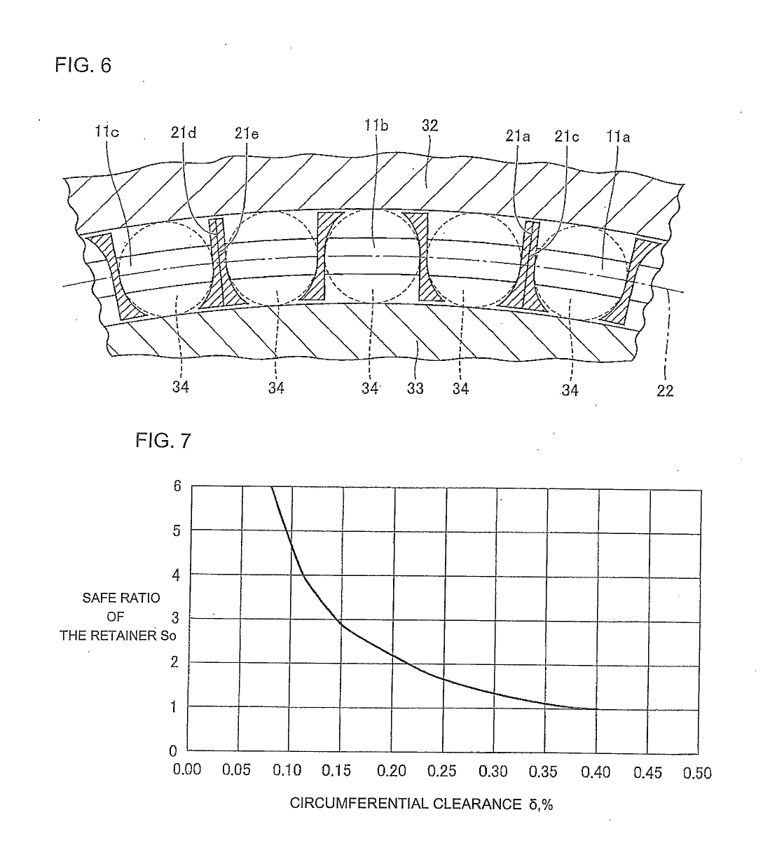

Next, a description will be made of a configuration of the tapered roller bearing including the retainer segment 11a. FIG. 5 is a schematic cross-sectional view showing a tapered roller bearing 31 having the plurality of retainer segments 11a, 11b, 11c, and 11d arranged in the circumferential direction and taken from an axial direction. In addition, FIG. 6 is an enlarged cross-sectional view showing a part VI in FIG. 5. Since the retainer segments 11b, 11c, and 11d have the same configuration as that of the retainer segment 11a except for the circumferential lengths, their descriptions are omitted. Here, the retainer segments 11a to 11d include the one having the different circumferential length, depending on a circumferential clearance which will be described below. In addition, in FIG. 5, the tapered roller held in the retainer segment 11a is omitted. Here, among the retainer segments 11a to 11d, it is assumed that the retainer segment arranged first is the retainer segment 11a, and the retainer segment arranged last is the retainer segment 11d.

Referring to FIGS. 5 and 6, the tapered roller bearing 31 includes an outer ring 32, an inner ring 33, a plurality of tapered rollers 34, and the plurality of retainer segments 11a to 11d. Here, it is assumed that an outer diameter dimension of the outer ring 32 is 2500 mm, and an inner diameter dimension of the inner ring 33 is 2000 mm. The retainer segments 11a to 11d are arranged so as to be continuously lined with each other in the circumferential direction without space therebetween. More specifically, the retainer segment 11a is arranged first, and then the retainer segment 11b is arranged such that it abuts on the retainer segment 11a, that is, such that the end face 21a of the retainer segment 11a abuts on an end face 21c of the retainer segment 11b. Then, the retainer segment 11c is arranged such that it abuts on the retainer segment 11b, that is, such that an end face 21d of the retainer segment 11b abuts on an end face 21e of the retainer segment 11c. Thus, the retainer segments are continuously arranged, and the retainer segment 11d is arranged last. In this way, the retainer segments 11a to 11d are arranged so as to be lined with each other in the circumferential direction. In this case, a circumferential clearance 39 is provided between the first retainer segment 11a and the last retainer segment 11d.

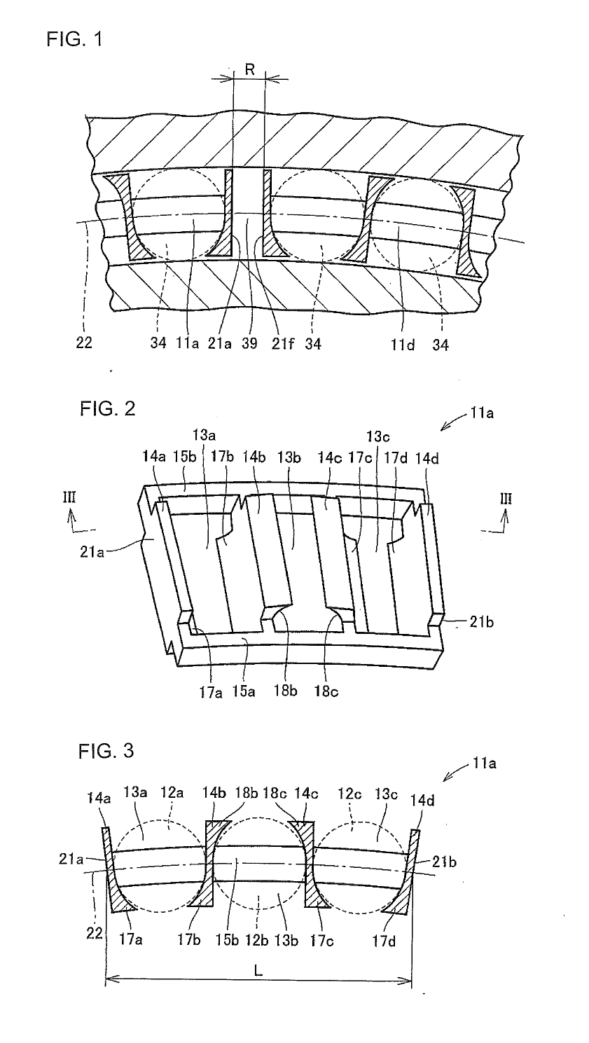

Then, a description will be made of the circumferential clearance between the first retainer segment 11a and the last retainer segment 11d. FIG. 1 is an enlarged cross-sectional view showing a part I in FIG. 5. Here, a circumferential dimension R of the circumferential clearance 39 is set to be larger than 0.08% and smaller than 0.10% of a circumference of a circle passing through the centers of the retainer segments 11a to 11d.

Hereinafter, a description will be made of a method for adjusting the circumferential clearance 39 between the retainer segments 11a and 11d of the tapered roller bearing 31. Here, it is assumed that the one tapered roller bearing 31 has the twenty retainer segments. First, the plurality of first and second retainer segments having the different circumferential lengths are prepared. Then, the twenty first retainer segments having the shortest circumferential length are arranged. Then, the circumferential clearance 39 is measured. When the circumferential clearance 39 is too large, that is, when the circumferential range of the clearance 39 is larger than 0.10% of the circumference of the circle passing through the centers of the retainer segments 11a to 11d, the several first retainer segments are replaced with the second retainer segments having the second circumferential length longer than the first circumferential length. That is, the number of the retainer segments having the different circumferential length to be replaced is adjusted in order that the circumferential range of the clearance 39 may be larger than 0.08% and smaller than 0.10%. Thus, the circumferential clearance between the retainer segments is adjusted. As described above, the first retainer segments having the first circumferential length and the second retainer segments having the second circumferential length different from the first circumferential length are prepared, and at least the first retainer segment and the second retainer segment are combined to adjust the circumferential clearance between the retainer segments.

According to the above method, the circumferential clearance 39 can be easily adjusted to the predetermined dimension by combining the retainer segments having the different circumferential lengths. Thus, the circumferential clearance 39 can be easily adjusted to within a small range. That is, the circumferential clearance 39 can be easily adjusted by combining the various retainer segments having the different circumferential lengths. Therefore, the circumferential clearance 39 can be easily adjusted.

Here, at least the first retainer segment and the second retainer segment are combined, which means that in addition to the first retainer segment having the first circumferential length and the second retainer segment having the second circumferential length, a third retainer segment having a third circumferential length different from the first and second circumferential lengths may be combined, and a retainer segment having a circumferential length different from those of the first, second, and third retainer segments may also be combined to adjust the circumferential clearance 39.

FIG. 7 is a graph showing a relationship between the circumferential clearance 39 and a safe ratio of the retainer. Referring to FIGS. 1 to 7, the safe ratio of the retainer composed of the retainer segments 11a to 11d is required to be 4.0 or more in view of fatigue strength of the material of the retainer segments 11a to 11d, and stress generated in the retainer segments 11a to 11d. Here, when the circumferential clearance 39 is 0.10% of the circumference, the safe ratio is about 4.6, so that the safe ratio can be surely 4.0 or more when the circumferential clearance 39 is set to be less than 0.10% of the circumference. Thus, a strength defect can be prevented from being caused by collision between the retainer segments 11a to 11d.

Here, the linear expansion coefficient Kb of the retainer segment 11a is about 1.5×10⁻⁵/° C. Meanwhile, the bearing component member such as the outer ring is made of case-hardening steel, and its linear expansion coefficient Ka is about 1.12×10⁻⁵/° C. Thus, a difference in expansion amount is expressed by the following formula 1 in which Δt represents a temperature rise and δ represents a difference in expansion amount between the members after the temperature rise.

δ=2πr·(Kb−Ka)·Δt [Formula 1]

In this case, even when only the retainer segment 11a rises to 50° C., the difference δ in expansion amount is 0.08%. In addition, even when the tapered roller bearing is heated such that Δt=100° C. in shrink-fitting, the difference δ in expansion amount is 0.035%. Therefore, when the circumferential clearance is set to be larger than 0.08%, the difference in thermal expansion between the bearing component such as the outer ring 32 or the inner ring 33 and the retainer segments 11a to 11d is allowable in the actual usage. Thus, it is prevented that the circumferential clearance 39 becomes negative, and the retainer segments 11a to 11d push each other can be avoided. As a result, the retainer segments 11a to 11d can be prevented from being deformed due to pushing.

As described above, the circumferential clearance generated between the retainer segments is adjusted by combining at least the first retainer segments having the first circumferential length, and the second retainer segments having the second circumferential length different from the first circumferential length, so that the circumferential clearance can be easily reduced. Thus, the circumferential clearance between the retainer segments is set within the above range by combining at least the first retainer segments having the first circumferential length, and the second retainer segments having the second circumferential length different from the first circumferential length, thereby preventing the strength defect caused by the collision between the retainer segments, and the deformation of the retainer segments 11a to 11d due to circumferential pushing. Therefore, functional decline can be easily prevented in the roller bearing having the above retainer segments.

In this case, when the retainer segments 11a to 11d are made of the resin containing the filler material to lower the thermal linear expansion coefficient, and the circumferential clearance 39 between the retainer segments 11a and 11d is set within the above range, the difference in thermal linear expansion coefficient can be small between the retainer segment and the bearing component member such as the outer ring 32 in the tapered roller bearing 31, thereby reducing a change in the circumferential clearance due to temperature change.

In addition, the thermal linear expansion coefficient of the retainer segments 11a to 11d is preferably set to be equal to at least one of the thermal linear expansion coefficients of the outer ring 32 and the inner ring 33. Thus, the difference in thermal linear expansion coefficient can be small between the retainer segments 11a to 11d, and the bearing component member such as the outer ring 32 in the tapered roller bearing 31, thereby reducing the change in the circumferential clearance 39 due to temperature change. Thus, the circumferential clearance 39 between the retainer segments 11a and 11d can be kept within the above range. Therefore, the functional decline can be easily prevented in the roller bearing having the above retainer segments.

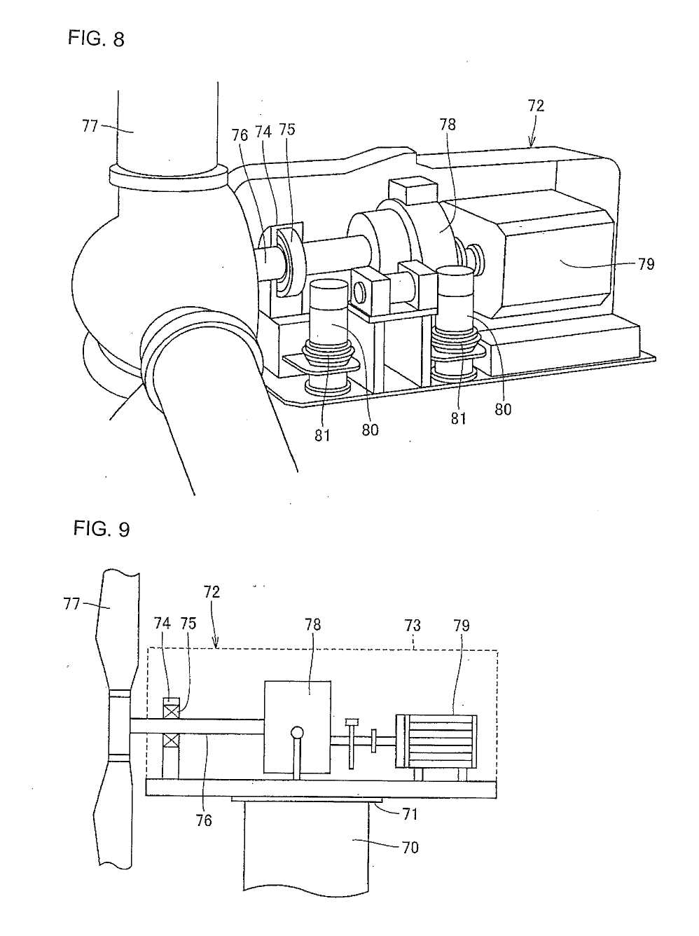

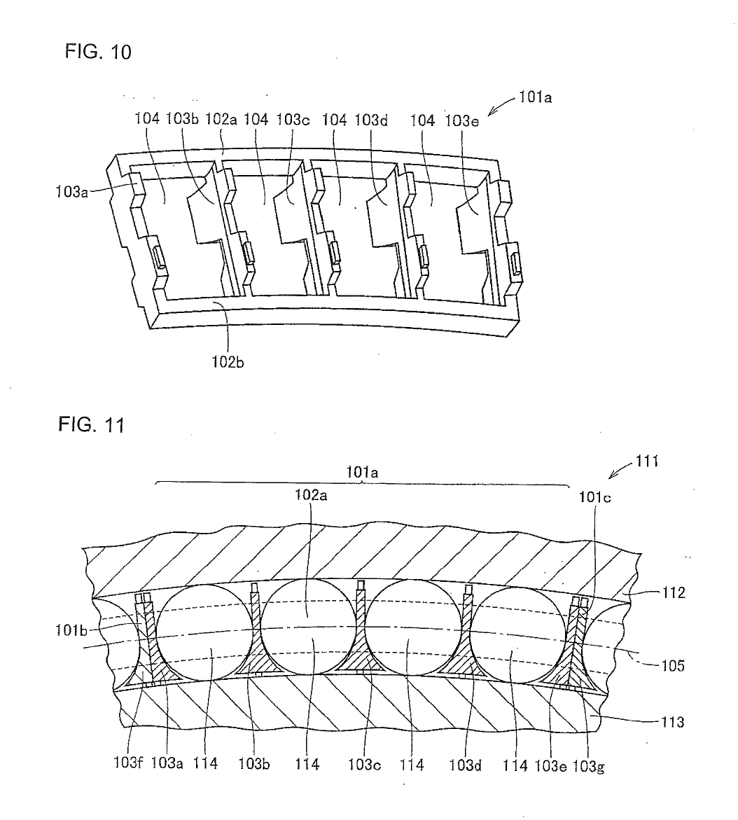

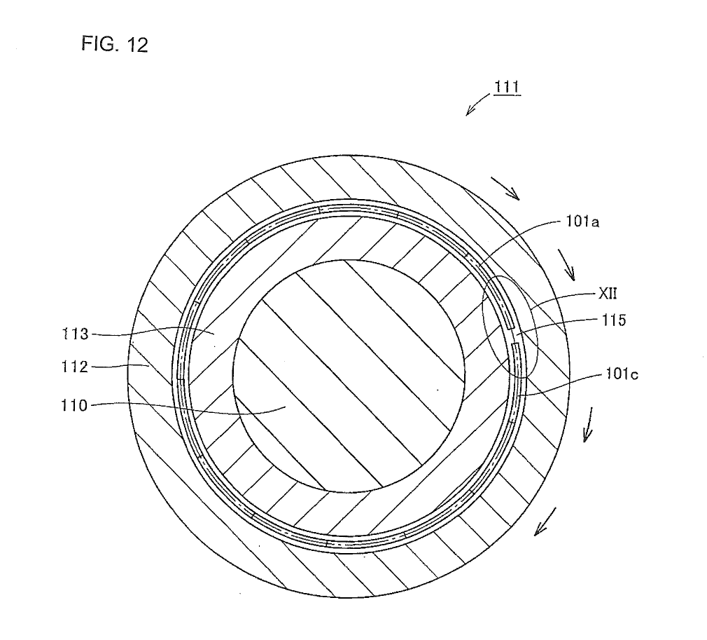

FIGS. 8 and 9 show one example of a main shaft support structure of a wind power generator in which the tapered roller bearing according to one embodiment of the present invention is employed as a main shaft support bearing 75. A casing 73 of a nacelle 72 to support a main part of the main shaft support structure is set over a support table 70 so as to be able to horizontally swirl, with a swivel base bearing 71 interposed therebetween, at a high position. A main shaft 76 has one end fixed to a blade 77 to receive wind power and is rotatably supported by the main shaft support bearing 75 housed in a bearing housing 74, in the casing 73 of the nacelle 72. The other end of the main shaft 76 is connected to a speed increase gearbox 78, and an output shaft of the speed increase gearbox 78 is coupled to a rotor shaft of a power generator 79. The nacelle 72 is swirled at a certain angle by a swirling motor 80 through a speed reduction gearbox 81.

The main shaft support bearing 75 housed in the bearing housing 74 is the tapered roller bearing according to one embodiment of the present invention and has the outer ring, the inner ring, the plurality of tapered rollers arranged between the outer ring and the inner ring, and the pockets to house the tapered rollers, and it includes the plurality of retainer segments arranged so as to be continuously lined with each other between the outer ring and the inner ring in the circumferential direction. The plurality of retainer segments include at least the first retainer segment having the first circumferential length, and the second retainer segment having the second circumferential length different from the first circumferential length. After the retainer segments have been arranged in the circumferential direction without space therebetween, the circumferential clearance is provided between the retainer segment arranged first and the retainer segment arranged last. Here, at room temperature, the circumferential range of the clearance is larger than 0.08% and smaller than 0.10% of the circumference of the circle passing through the center of the retainer segment.

Since the main shaft support bearing 75 supports the main shaft having the one end fixed to the blade 77 which receives great wind power, it needs to receive high moment load, thrust load, and radial load. Here, when the tapered roller is employed as the roller, it can receive the high moment load.

In addition, since the main shaft support structure of the wind power generator includes the tapered roller bearing in which the functional decline can be easily prevented, functional decline can be easily prevented in the main shaft support structure itself of the wind power generator.

In addition, while the circumferential range of the clearance is set so as to be larger than 0.08% and smaller than 0.10% of the circumference of the circle passing through the center of the retainer segment at room temperature in the above embodiment, its upper limit value may be smaller, that is, may be smaller than 0.10%. In this case, the deformation caused by the collision can be further prevented.

In addition, as described above, the tapered roller bearing may include the retainer segment having the third circumferential length different from the first and second circumferential lengths. More specifically, the third circumferential length is 102 mm. That is, the tapered roller bearing may include the plurality of retainer segments having the first, second, and third circumferential lengths. In addition, it may further include a retainer segment having a different circumferential length.

In addition, while the retainer segment is made of the resin in the above embodiment, the present invention is not limited to this and can be applied to an iron retainer segment.

Furthermore, the above tapered roller bearing may be employed as a rotation shaft support structure of a tunnel boring machine. That is, the rotation shaft support structure of the tunnel boring machine includes a cutter head provided with a cutter to bore earth and sand, a rotation shaft provided with the cutter head at one end and rotating together with the cutter head, and a double-row tapered roller bearing incorporated in a fix member to rotatably support the rotation shaft. The double-row tapered roller bearing has an outer ring, an inner ring, a plurality of tapered rollers arranged between the outer ring and the inner ring, and pockets to house the tapered rollers, and includes a plurality of retainer segments arranged so as to be continuously lined with each other in the circumferential direction between the outer ring and the inner ring. The retainer segments include at least a first retainer segment having a first circumferential length, and a second retainer segment having a second circumferential length different from the first circumferential length. After the retainer segments have been arranged in the circumferential direction without space therebetween, a circumferential clearance is provided between the retainer segment arranged first and the retainer segment arranged last. Here, at room temperature, a circumferential range of a clearance is larger than 0.08% and smaller than 0.10% of a circumference of a circle passing through the center of the retainer segment.

In this configuration also, functional decline can be easily prevented in the rotation shaft support structure of the tunnel boring machine. In this case, a seal to prevent a foreign material from entering the bearing may be provided.

In addition, while the tapered roller is used as the roller housed in the retainer segment in the above embodiment, the roller is not limited to this, and a cylindrical roller, needle roller, or rod roller may be used.

Furthermore, while the outer diameter dimension of the outer ring is 2500 mm, and the inner diameter dimension of the inner ring is 2000 mm in the above embodiment, the present invention is not limited to this and may be applied to a large-size roller bearing in which an outer diameter dimension of an outer ring is 1000 mm or more, and an inner diameter dimension of an inner ring is 750 mm or more. In addition, a large-size roller bearing actually used in the above usage may be the one including an outer ring having an outer diameter dimension of 5000 mm or less, and an inner ring having an inner diameter dimension of 4500 mm or less.

While the embodiments of the present invention have been described with reference to the drawings in the above, the present invention is not limited to the above-illustrated embodiments. Various kinds of modifications and variations may be added to the illustrated embodiments within the same or equal scope of the present invention.

### INDUSTRIAL APPLICABILITY

The roller bearing according to the present invention is effectively applied to a main shaft support structure of a wind power generator required to prevent functional decline.

In addition, the main shaft support structure of the wind power generator according to the present invention can be effectively used when it is required to prevent functional decline.

In addition, the method for adjusting the circumferential clearance between the retainer segments can be effectively used when it is required to easily adjust a circumferential clearance.

### EXPLANATION OF REFERENCES

11A, 11B, 11C, 11D RETAINER SEGMENT, 12A, 12B, 12C, 34 TAPERED ROLLER, 13A, 13B, 13C POCKET, 14A, 14B, 14C, 14D COLUMN PART, 15A, 15B CONNECTION PART, 17A, 17B, 17C, 17D, 18B, 18C GUIDE CLICK, 21A, 21B, 21C, 21D, 21E, 21F END FACE, 22 PCD, 31 TAPERED ROLLER BEARING, 32 OUTER RING, 33 INNER RING, 39 CLEARANCE, 70 SUPPORT TABLE, 71 SWIVEL BASE BEARING, 72 NACELLE, 73 CASING, 74 BEARING HOUSING, 75 MAIN SHAFT SUPPORT BEARING, 76 MAIN SHAFT, 77 BLADE, 78 SPEED INCREASE GEARBOX, 79 POWER GENERATOR, 80 SWIRLING MOTOR, 81 SPEED REDUCTION GEARBOX

1. A roller bearing comprising an outer ring, an inner ring, a plurality of rollers arranged between said outer ring and said inner ring, and pockets to house said rollers, and including a plurality of retainer segments arranged so as to be continuously lined with each other in a circumferential direction between said outer ring and said inner ring, wherein
said plurality of retainer segments include at least a first retainer segment having a first circumferential length, and a second retainer segment having a second circumferential length different from said first circumferential length,
a circumferential clearance is provided between the retainer segment arranged first and the retainer segment arranged last after said plurality of retainer segments have been arranged in the circumferential direction without space therebetween, and
a circumferential range of said clearance is larger than 0.08% and smaller than 0.10% of a circumference of a circle passing through a center of said retainer segment at room temperature.

2. The roller bearing according to claim 1, wherein
said retainer segment is made of a resin.

3. The roller bearing according to claim 2, wherein
said resin is polyether ether ketone.

4. The roller bearing according to claim 2, wherein
said resin contains a filler material to lower a thermal linear expansion coefficient.

5. The roller bearing according to claim 4, wherein
said filler material contains at least one of carbon fiber and glass fiber.

6. The roller bearing according to claim 2, wherein
a thermal linear expansion coefficient of said resin ranges from 1.3×10⁻⁵/° C. to 1.7×10⁻⁵/° C.

7. The roller bearing according to claim 1, wherein
a thermal linear expansion coefficient of said retainer segment is equal to at least one of thermal linear expansion coefficients of said outer ring and said inner ring.

8. The roller bearing according to claim 4, wherein
a filling rate of said filler material in said resin ranges from 20% by weight to 40% by weight.

9. The roller bearing according to claim 1, wherein
said roller is a tapered roller.

10. A main shaft support structure of a wind power generator comprising:
a blade to receive wind power;
a main shaft having one end fixed to said blade and rotating together with said blade; and
a roller bearing incorporated in a fix member to rotatably support said main shaft, wherein
said roller bearing comprises an outer ring, an inner ring, a plurality of rollers arranged between said outer ring and said inner ring, and pockets to house said rollers, and including a plurality of retainer segments arranged so as to be continuously lined with each other in a circumferential direction between said outer ring and said inner ring,
said plurality of retainer segments include at least a first retainer segment having a first circumferential length, and a second retainer segment having a second circumferential length different from said first circumferential length,
a circumferential clearance is provided between the retainer segment arranged first and the retainer segment arranged last after said plurality of retainer segments have been arranged in the circumferential direction without space therebetween, and
a circumferential range of said clearance is larger than 0.08% and smaller than 0.10% of a circumference of a circle passing through a center of said retainer segment at room temperature.

11. A method for adjusting a circumferential clearance between retainer segments of a roller bearing comprising an outer ring, an inner ring, a plurality of rollers arranged between said outer ring and said inner ring, and pockets to house said rollers, and including a plurality of retainer segments arranged so as to be continuously lined with each other in a circumferential direction between said outer ring and said inner ring, comprising:
a step of preparing a first retainer segment having a first circumferential length, and a second retainer segment having a second circumferential length different from said first circumferential length; and
a step of combining at least said first retainer segment and said second retainer segment to adjust the circumferential clearance between the retainer segments.
